(19) United States
(12) Patent Application Publication
(10) Pub. No.: US 2003/0127365 A1
(43) Pub. Date: Jul. 10, 2003

(54) Method of analyzing a plurality of objects

(76) Inventors: Knud Thomsen, Aarhus (DK); Peter Mikkelsen, Odder (DK); Peter Locht, Viby J. (DK)

Correspondence Address: MERCHANT & GOULD PC, P.O. BOX 2903, MINNEAPOLIS, MN, 55402-0903, US

(21) Appl. No.: 10/181,092

(22) PCT Filed: Jan. 15, 2001
(86) PCT No.: PCT/DK01/00022

(30) Foreign Application Priority Data
Jan. 13, 2000 (DK) PA 2000 0036

(51) Int. Cl. B07B 1/00; B03B 1/00

(52) U.S. Cl. 209/1

(57) ABSTRACT

In a method of analyzing a plurality of objects, which each are expressed by a set of parameters consisting of a plurality of parameter values, a plurality of samples (predetermined objects) is divided into a plurality of classes. These objects may inter alia be represented by colour pixels in an image processing system, wherein each object is identified by a set of parameters formed by a plurality of parameters, e.g. the intensities of the 3 primary colours. Sets of parameters additionally include e.g. those which are related to marketing, economic, financial, legal, organizing, sociological, anthropological, historic, linguistic, psychological or political scenarios. The sets of parameters of the samples, which are expressed as a set of numbers, determine in which of the classes the individual samples are arranged. The classes of the objects are established by given criteria, such as distance relations in vector form between the sets of parameters of the objects and the sets of parameters of the samples. In the event that a sample may be arranged in more than one class, the one of the classes in which the sample might be arranged according to predetermined criteria is selected, or the sample is left out in the analysis. With a relatively small object material, the invented method makes it possible to estimate analysis results of objects with a large number of parameter values, which is e.g. of great importance if the numbers for the object material are expensive and difficult to provide.

The invention relates to a method of analyzing a plurality of objects, wherein the analysis is performed by classification of the objects, each object being identified by a set of parameters, which are expressed as a value, such as a number, an integer, a real number or a complex number.

In many connections there is a need for analyses of objects which are represented by so-called sets of parameters.

Examples of such sets of parameters include culturally related ones, such as marketing, economic, financial, legal, organizing, sociological, anthropological, historic, linguistic, psychological or political sets of parameters.

As further examples it may be mentioned that the sets of parameters may also be formed by physical quantities, such as intensity values of objects which consist of a plurality of colour pixels in an image processing system.

Analyses of these sets of parameters are performed in analysis systems which are built on the basis of preclassified sets of parameters, in the sense that some rules for a given analysis are made automatically by the analysis system, which define some classes to each of which some sets of parameters are allocated.

The sets of parameters are n-dimensional and thereby contain n parameters which may be expressed as a parameter value by a number, an integer, a real number or a complex number, which is then expressed as two real numbers, corresponding to the real part and the imaginary part of the complex number.

In connection with preclassification of sets of parameters it is frequently impossible to avoid situations of conflict, i.e. events where a set of parameters may be referred to more than 1 class.

Owing to the reliability in the making of rules for the classes it is important that rules for conflicts are made, since, otherwise, error sources will be introduced in analyses proper, in the sense that various classes are allocated to objects which belong to the same class.

U.S. Pat. No. 5,678,677 describes a classification system for the classification of coins and notes on the basis of parameters, which are expressed e.g. as colour properties, wherein a plurality of colour pixels are preclassified, thereby subjecting the system to learning. Nothing is said about handling of conflicts.

DK Patent No. 172 429 B1 concerns learning of an image processing system, wherein a plurality of classes are set up on the basis of a plurality of preclassified colour pixels. In the event that some of the preclassified colour pixels can occur in more than one class, i.e. there is a so-called conflict, then a special conflict class will be allocated to these colour pixels.

The classification system described in the DK patent is suitable as long as it is used in connection with sets of parameters which do not include too many dimensions or too many possible parameter values, i.e. the parameter space may be implemented as a discrete finite space. (In the patent, 3 dimensions are used, and with parameters as intensities of the 3 primary colours).

Accordingly, an object of the invention is to improve the known methods, so that they can be implemented in practice for a parameter space having a large number of dimensions/parameter values.

The object of the invention is achieved by the method according to claim 1, which comprises the steps of:

dividing and arranging a plurality of sample objects in a plurality of classes, whereby a plurality of sample objects having characteristics sets of parameters, which are expressed as a value, such as a number, an integer, a real number or a complex number, are allocated to each class,

classifying the objects on the basis of a relation between the sets of parameters of the sample objects and the sets of parameters of the objects,

either, on the basis of given criteria, arranging the objects which satisfy the conditions of arrangement in more than one class in one of these classes, or excluding them from classification.

This method thus provides the advantages that could be achieved by the method defined in DK Patent No. 172 429 B1, but can now be performed in practice with a large number of parameter values in a large n-dimensional space, since the relation between the sets of parameters can be performed, without it being necessary to use a very great computing power that is almost impossible to apply in practice.

In other words, owing to the use of the relation, it is possible to operate with a smaller event space for sets of parameters, since not all possible combinations of parameters occurring in a discrete space need be incorporated in the calculations, it being sufficient to use the actual number of sample objects and the actual number of objects which are to be classified.

Also, it is possible to handle situations of conflict, as conditions of conflicts may e.g. be user-defined as objects having sets of parameters which mean that the relation will allow the object to be arranged in more than 1 class.

Expediently, the invention may be implemented, as stated in claim 2, by using as objects a plurality of colour pixels in an image processing system, wherein each colour pixel is identified by a set of parameters which is formed by a plurality of intensity values.

In many types of analyses it is an advantage if, as stated in claim 3, the relation is determined as a distance relation, and the objects are arranged in the classes where the distance relation is smallest.

Moreover, this distance relation is expediently realizable in connection with situations of conflict, as a conflict may merely be identified such that if their mutual distance value is smaller than a certain minimum value, then there is a conflict.

Further expedient embodiments of the relations are defined in claims 3-6.

For use in the adaptation of sets of parameters in connection with numerical analyses, it is advantageous if, as stated in claim 7, the parameters of the samples or of the objects are weighted relatively to each other.

Further, it is expedient if, as stated in claim 8, the relation is determined as a “relation of greatest similarity”, and a small weight is allocated to the parameters in the set of parameters of the objects and the sample objects which differ most from each other in the calculation of the parameter value which is used for the allocation of a class.

Hereby, an otherwise great general similarity between the parameters (and thereby the parameter values) in a set of parameters may be “cleaned” of contributions from parameters which are irrelevant or directly misleading for the desired classification.

Since the analysis according to the invention is based on preclassification of a plurality of samples on the basis of their sets of parameters, the “reliability” of the analysis may be verified, if, as stated in claim 9, after all samples have been classified, a plurality of the samples is taken, following which they are classified on the basis of the remaining samples, and it is determined how many of the classified samples are classified correctly as a function of the plurality of samples taken.

Hereby, in addition to determining the “reliability”, it is possible to determine how large an object material is to be analyzed before an analysis result can be predicted with a certain percentage accuracy.

If it is desired to provide an analysis material with few risks of conflict, it is an advantage if, as stated in claim 10, classification of an object is performed by calculating for each class a number S_{d}, which is expressed by

S_{d}Σdᵢ⁻⁰, for i=1 to k,

where k, which is user-defined, is the plurality of closest neighbours of the object in each class,

dᵢ is the distance to the i′th set of parameters belonging to the class, and

e is a user-defined exponent, where e>0, the class where S_{d} is greatest being selected as the class for the object concerned.

Hereby, in the classification, several sets of parameters are considered in each class by determination of the class in which the object is to be arranged.

If a particularly easy way of providing the classes is desired, it is possible, as stated in claim 11, to do this in that the classes are determined by using the value of at least one parameter in a set of parameters as a classification criterion.

In other words, the value of one of the parameters in a set of parameters is used as a classification symbol.

Expediently, as stated in claim 12, the classes may be determined in that an interpolation value of a plurality of parameters in a corresponding plurality of sets of parameters is used as a classification criterion, which means that samples with a relatively great consistency are more representatively related to the same class.

Below, three examples are described with respect to practical performance of analyses in which the principles of the invention are applied.

### EXAMPLE 1

A sample material of 2054 sample objects has been divided in advance into 5 classes, A, B, C, D, E.

The parameter values are set to 0, 25, 50, 75, 100, or undefined.

Each sample object has 20 parameters (20-dimensional) corresponding to a total of 61140 parameter sections (20×3057), of which 6250 are undefined.

These undefined parameter values are set to the value 50. It is noted that no conflict handling is used in this example.

Now a pluralty N of the 2054 sample objects is selected, which is classified by means of the remaining sample objects (2054-N).

It is now determined for various values of N how many are classified correctly.

The result is shown in the table below:

TABLE 1

| Number N | | Correct class in % | Average of the |
|---|---|---|---|
| classified | 2054-N | of the cases | tests |
| 1 | 2053 | 80.0 | 1000 |
| 2 | 2052 | 80.0 | 1000 |
| 5 | 2049 | 80.0 | 1000 |
| 10 | 2044 | 79.6 | 1000 |
| 20 | 2034 | 89.0 | 1000 |
| 50 | 2004 | 79.4 | 100 |
| 100 | 1954 | 80.0 | 100 |
| 200 | 1854 | 80.3 | 10 |
| 500 | 1554 | 79.0 | 10 |
| 1000 | 1054 | 78.6 | 10 |
| 1100 | 954 | 78.2 | 10 |
| 1200 | 854 | 78.2 | 10 |
| 1300 | 754 | 77.6 | 10 |
| 1400 | 654 | 78.0 | 10 |
| 1500 | 554 | 77.5 | 10 |
| 1600 | 454 | 76.8 | 10 |
| 1700 | 354 | 76.7 | 10 |
| 1800 | 254 | 75.8 | 10 |
| 1900 | 154 | 74.3 | 10 |
| 2000 | 54 | 70.7 | 10 |
| 2025 | 29 | 68.2 | 10 |
| 2030 | 24 | 68.2 | 10 |
| 2040 | 14 | 66.1 | 10 |
| 2050 | 4 | 59.1 | 10 |
| 2052 | 2 | 44.9 | 10 |
| 2053 | 1 | 27.9 | 10 |

It will be seen from the table that with non-election of between 1 and 2000 samples between about 70 and 80% of the samples is classified correctly, which may be compared with the situation that if a class was allocated to all the samples according to the slump principle, then only 20% would be arranged in the correct class.

With 70.7% correct classification it will be seen that the classification was based on the classification of just 54 sample objects by the method according to the invention.

In the case above it is noted that, as mentioned, the sample material contained samples which were designated undefined and given the parameter value 50.

### EXAMPLE 2

A classification similar to the one in example 1 was then made, but now with the difference that exclusively a sample material where all (a total of 1140) have defined values was used.

The result is shown in the table below:

TABLE 2

| Number N | | Correct class in % | |
|---|---|---|---|
| classified | 1140-N | of the cases | Average of tests |
| 1 | 1139 | 80.0 | 1000 |
| 10 | 1130 | 78.0 | 1000 |
| 100 | 1040 | 78.0 | 100 |
| 200 | 940 | 76.4 | 10 |
| 500 | 640 | 76.4 | 10 |
| 1000 | 140 | 74.0 | 10 |
| 1050 | 90 | 72.9 | 10 |
| 1100 | 40 | 70.3 | 10 |
| 1110 | 30 | 68.7 | 10 |
| 1120 | 20 | 65.9 | 10 |
| 1130 | 10 | 62.1 | 10 |

This table shows the same pattern as table 1.

In other words, it has had no significant importance that the sample material contained undefined or predetermined parameter values.

### EXAMPLE 3

In an image processing system, where it is e.g. desired to analyze the characteristic region in an image, such as an image taken from a microscope, a set of parameters is allocated to each pixel in the image, each set of parameters consisting of 3 elements (parameters) which may be intensities of the 3 primary colours.

If it is assumed that the intensities are determined with a very high resolution, it is evident that the event space indicating all possible combinations of sets of parameters may be very comprehensive, and even with the modem very fast computers having a great storage capacity, it is impossible in practice to carry out calculations because of a huge storage requirement.

By applying the principles of the invention, and by just using the actually detected sets of parameters in the calculation, and by forming a relation between a plurality of sample colour pixels having characteristic sets of parameters (or predefined colour pixels) and the plurality of detected colour pixels, it is possible to analyze an image with sets of parameters that can be represented by very great event spaces, since the event space is “reduced” to a virtual event space whose size just depends on how many sets of parameters a user wants to detect.

Finally, it should be noted in connection with the examples that it is not possible to achieve a higher correct classification than about 80% because of overlap in the parameter space.

1. A method of analyzing a plurality of objects, wherein the analysis is performed by classification of the objects, each object being identified by a set of parameters, which are expressed as a value, such as a number, an integer, a real number or a complex number, and comprising the steps of:
dividing de objects in a plurality of classes, whereby a plurality of sample objects having characteristics sets of parameters, which are expressed as a value, such as a number, an integer, a real number or a complex number, are allocated to each class,
classifying the objects on the basis of a relation between the sets of parameters of the sample objects and the sets of parameters of the objects,
either, on the basis of given criteria, arranging the objects which satisfy the conditions of arrangement in more than one class in one of these classes, or excluding them from classification.

2. A method according to claim 1, characterized by using as objects a plurality of colour pixels in an image processing system, each colour pixel being identified by a set of parameters which is formed by a plurality of parameters represented by intensity values.

3. A method according to claim 1 or 2, characterized by determining the relation as a distance relation, and arranging the objects in the classes where the distance relation is smallest.

4. A method according to claims 1-3, characterized by determining the distance relation as a Euclidean relation of the form:
dD²=(Pᵢ−Pⱼ)², where
dD represents the distance, while
Pᵢ represents the parameter value for the i′th element, and
Pⱼ represents the parameter value for the j′th element.

5. A method according to claim 1 or 2, characterized by determining the distance relation as a non-Euclidean relation, the distance being expressed as a number in such a manner that the numbers may be arranged mutually by size.

6. A method according to claim 1 or 2, characterized by determining the relation as a deviation between the parameter values of the objects which are expressed as a number.

7. A method according to claims 1-6, characterized by weighting the parameter values of the samples and/or of the objects relatively to each other.

8. A method according to claim 1 or 2, characterized by determining the relation as a “relation of greatest similarity”, and allocating to the parameters in the sets of parameters of the objects and of the sample objects that differ most from each other a small weight in the calculation of the parameter value which is used for the allocation of a class.

9. A method according to claims 1-8, characterized by taking a plurality of the samples after all samples have been classified, and then classifying them on the basis of the remaining samples, and determining how many of the classified samples are classified correctly as a function of the plurality of samples taken.

10. A method according to claims 1-8, characterized by performing the classification of an object by calculating for each class a number Sd which is expressed by
S_{d}=Σdᵢ^{-e}, for i=1 to k,
where k, which is user-defined, is the plurality of closest neighbours of the object in each class,
dᵢ is the distance to the i′th set of parameters belonging to the class, and
e is a user-defined exponent, where e>=0, the class where Sd is greatest being selected as the class for the object concerned.

11. A method according to claim 1 or 2, characterized by determining the classes by using the value of at least one parameter in a set of parameters as a classification criterion.

12. A method according to claim 11, characterized by determining the classes by using an interpolation value of a plurality of parameters in a corresponding plurality of sets of parameters as a classification criterion.
